(19) United States
(12) Patent Application Publication
(10) Pub. No.: US 2025/0266188 A1
(43) Pub. Date: Aug. 21, 2025

(54) GROMMET

(71) Applicant: YAZAKI CORPORATION, Tokyo (JP)

(72) Inventors: Hirotaka Kiyota, Makinohara-shi (JP); Takeshi Onoda, Makinohara-shi (JP); Toshinori Yamada, Makinohara-shi (JP)

(21) Appl. No.: 19/204,452

(22) Filed: May 9, 2025

Related U.S. Application Data
(63) Continuation of application No. PCT/JP2024/008411, filed on Mar. 6, 2024.

(30) Foreign Application Priority Data
Apr. 6, 2023 (JP) 2023-062329

(51) Int. Cl. H01B 17/58

(52) U.S. Cl. CPC H01B 17/583

(57) ABSTRACT

A hard resin base member of a grommet includes an annular flange. An elastically deformable soft resin grommet body includes an annular body. An annular lip is brought into tight contact with a first annular wall surface of the flange on an outer peripheral edge portion side at an assembly completion position. A first annular portion is coaxially disposed to face an outer peripheral edge portion of the annular body on an outer peripheral edge portion side of the flange with a gap therebetween. A second annular portion connects the outer peripheral edge portion of the annular body to an outer peripheral edge portion of the first annular portion. The first annular portion is hooked to the outer peripheral edge portion of the flange from a second annular wall surface side on a back side of the first annular wall surface over an entire circumference.

### CROSS-REFERENCE TO RELATED APPLICATION

This application is a continuation application of International Application No. PCT/JP2024/008411 filed on Mar. 6, 2024 which claims the benefit of priority from Japanese Patent Application No. 2023-062329 filed on Apr. 6, 2023 and designating the U.S., the entire contents of which are incorporated herein by reference.

### BACKGROUND OF THE INVENTION

### 1. Field of the Invention

The present invention relates to a grommet.

### 2. Description of the Related Art

Conventionally, in a wire harness, a wiring member such as an electric wire is inserted into a through hole provided in an insertion object (e.g., a panel of a vehicle body in a vehicle or the like), so that the wiring member is drawn from one space to the other space, the one space and the other space being separated by the insertion object. For this reason, in order to protect the wiring member from a peripheral edge of the through hole and to prevent liquid from entering a gap between the through hole and the wiring member, a grommet that closes the gap is attached to the insertion object. For example, the grommet is made of a hard synthetic resin material, and includes a base member allowing a wiring member to pass thereinto between one space and the other space, and an annular grommet body made of a synthetic resin material having flexibility such as rubber. The grommet is inserted into the through hole to bring the grommet body into tight contact with the peripheral edge of the through hole in the insertion object. In this grommet, the base member and the grommet body are integrally formed by an integral molding technique such as two-color molding. This type of grommet is disclosed in, for example, Japanese Patent Application Laid-open No. JP H08-251 769 A.

Incidentally, in the conventional grommet, when a mold for integrally molding the base member and the grommet body is removed, it is necessary to suppress deterioration in quality of the flexible grommet body by reducing a load applied to the grommet body from the mold. However, in this grommet, since the wiring member passes into the base member between one space and the other space, the size of the base member is larger than that of the grommet body, and the shape of the base member tends to be complicated. Therefore, depending on the shapes of the base member and the grommet body, it may be impossible to avoid an excessive load from the mold to the grommet body. Therefore, in this case, the base member and the grommet body may be prepared as separate parts, and the base member and the grommet body may be assembled together to reduce the load from the mold when molding the grommet body. However, in this grommet, it is necessary to keep the base member and the grommet body at an assembly completion position.

### SUMMARY OF THE INVENTION

Therefore, an object of the present invention is to provide a grommet capable of keeping a base member and a grommet body at an assembly completion position.

In order to solve the above mentioned problems and achieve the object, a grommet according to one aspect of the present invention includes a cylindrical base member into which a conductive wiring member is inserted to pass from one space to another space through a through hole of an insertion object, the base member being made of a hard synthetic resin material; and an annular grommet body coaxially assembled to the base member, and disposed in the one space at an attachment completion position with respect to a peripheral edge portion of the through hole of the insertion object, wherein the base member includes: an annular flange disposed in the one space at the attachment completion position and having an outer peripheral edge portion coaxially disposed to face the annular peripheral edge portion with a gap therebetween; and a cylindrical body protruding coaxially from the flange toward the another space and inserted into the through hole at the attachment completion position, the grommet body is an annular water-blocking member made of an elastically deformable synthetic resin material softer than the base member to be coaxially brought into tight contact with the outer peripheral edge portion of the flange at an assembly completion position with respect to the base member, and coaxially brought into tight contact with the peripheral edge portion at the attachment completion position, the grommet body includes: an annular body coaxially disposed to face a first annular wall surface of the flange on an outer peripheral edge portion side at the assembly completion position with a gap therebetween, and coaxially disposed to face the peripheral edge portion at the attachment completion position with a gap therebetween; an annular lip protruding coaxially from the annular body, and elastically deformed at the assembly completion position to be brought into tight contact with the first annular wall surface of the flange on the outer peripheral edge portion side over an entire circumference; a first annular portion coaxially disposed to face an outer peripheral edge portion of the annular body on an outer peripheral edge portion side of the flange with a gap therebetween; and a second annular portion protruding coaxially from the outer peripheral edge portion of the annular body toward the flange, and connecting the outer peripheral edge portion of the annular body to an outer peripheral edge portion of the first annular portion, and the first annular portion is hooked to the outer peripheral edge portion of the flange from a second annular wall surface side on a back side of the first annular wall surface over an entire circumference at the assembly completion position.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a grommet according to an embodiment;

FIG. 2 is a perspective view of the grommet according to the embodiment before being attached to an insertion object as viewed from another angle;

FIG. 3 is a plan view of the grommet according to the embodiment as viewed from a cylindrical body side;

FIG. 4 is a plan view of the grommet according to the embodiment as viewed from a tubular body side;

FIG. 5 is a view illustrating a cross section taken along line X-X of FIG. 4 together with an insertion object before being attached;

FIG. 6 is an exploded perspective view illustrating the grommet according to the embodiment;.

FIG. 7 is an exploded perspective view of the grommet according to the embodiment as viewed from another angle;

FIG. 8 is an exploded perspective view separately illustrating two base members after being assembled and a grommet body of the grommet according to the embodiment;

FIG. 9 is an exploded perspective view of a base member and a waterproof member according to the embodiment; and

FIG. 10 is a partial cross-sectional view illustrating a part of a mold for forming a grommet body according to the embodiment.

### DETAILED DESCRIPTION OF THE PREFERRED EMBODIMENTS

Hereinafter, an embodiment of a grommet according to the present invention will be described in detail with reference to the drawings. Note that the present invention is not limited by this embodiment.

### Embodiment

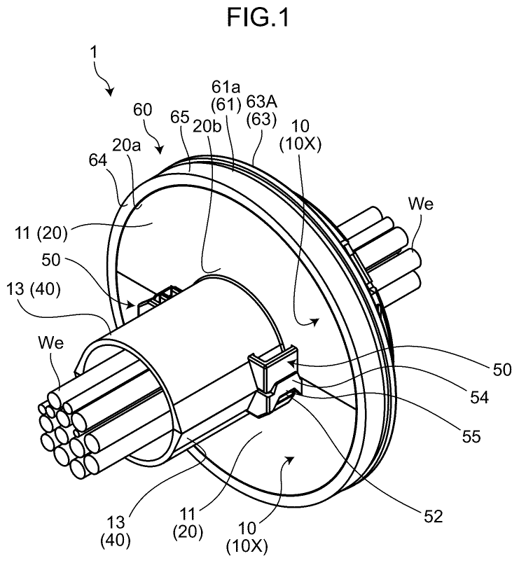

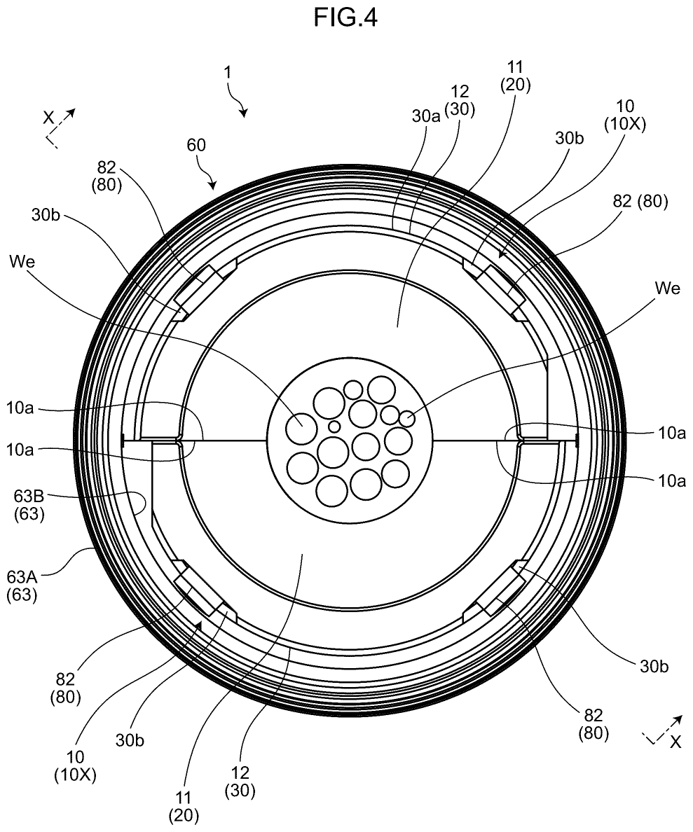

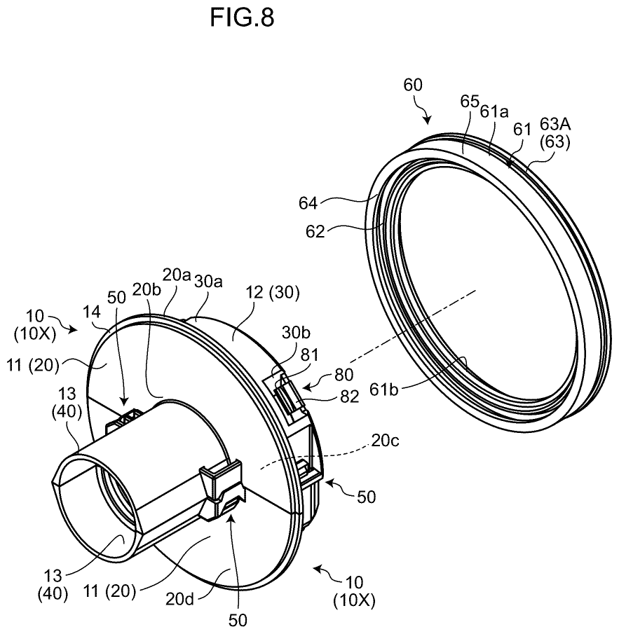

One embodiment of a grommet according to the present invention will be described with reference to FIGS. 1 to 10.

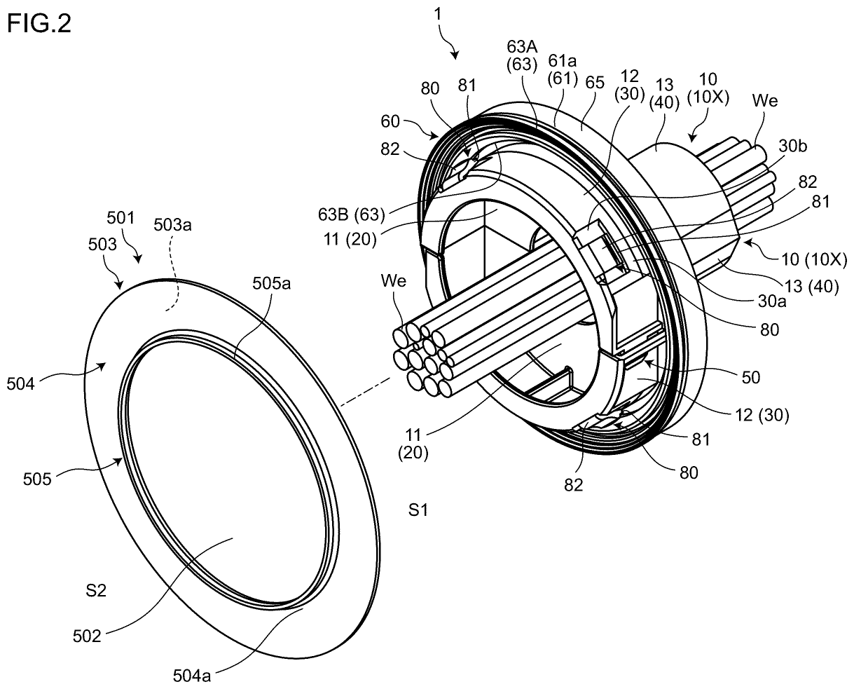

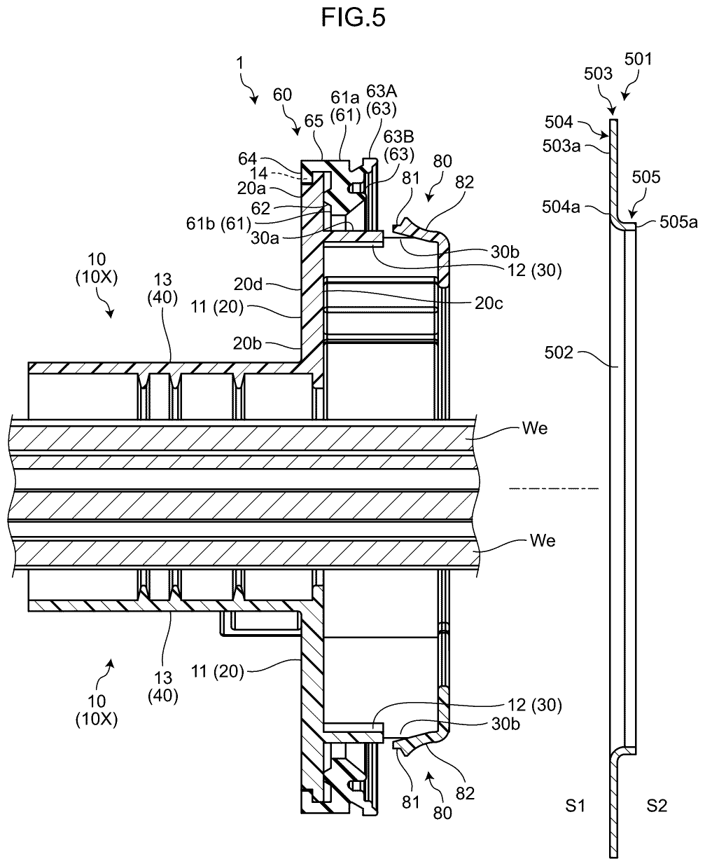

Reference numeral 1 in FIGS. 1 to 8 denotes a grommet according to the present embodiment. The grommet 1 protects a conductive wiring member We passing from one space S1 to the other space S2 through a through hole 502 of an insertion object 501 from a peripheral edge portion 503 of the through hole 502 in the insertion object 501, and prevents entry of liquid (water or the like) into a gap between the annular peripheral edge portion 503 and the wiring member We (FIGS. 2 and 5). Therefore, the grommet 1 is attached to the peripheral edge portion 503 of the through hole 502 of the insertion object 501 after the wiring member We is inserted into the grommet 1.

Here, the wiring member We is, for example, an electric wire (an electric wire as a communication wire, an electric wire as a power supply wire, or the like). The insertion object 501 is a member for inserting the wiring member We, and indicates, for example, a wall body such as a panel of a vehicle body in a vehicle. The wiring member We is inserted into the through hole 502 of the insertion object 501, and is thereby routed between one space S1 and the other space S2 separated by the insertion object 501. For example, the wiring member We serves to communicate between a device in one space S1 and a device in the other space S2, or serves to supply power to an electric device in one space S1 from a power source in the other space S2.

The peripheral edge portion 503 of the through hole 502 of the insertion object 501 includes a flat plate portion having an annular shape (hereinafter referred to as an “annular flat plate portion”) 504, and a protruding portion having an annular shape (hereinafter referred to as an “annular protruding portion”) 505 protruding from an end portion of an inner peripheral edge of the annular flat plate portion 504 (an inner peripheral edge portion 504a) toward the other space S2 (FIGS. 2 and 5). The grommet 1 is attached to the annular flat plate portion 504 and the annular protruding portion 505 in the peripheral edge portion 503. For example, the insertion object 501 is formed by press molding, and the annular flat plate portion 504 and the through hole 502 are formed at that time. In the insertion object 501, the annular protruding portion 505 is formed by burring the peripheral edge of the through hole 502. Here, since the through hole 502 is formed in a circular shape, each of the annular flat plate portion 504 and the annular protruding portion 505 is formed in an annular shape.

The grommet 1 includes a cylindrical base member 10X into which the wiring member We is inserted (FIGS. 1 to 9). The base member 10X may be formed of one member, or may be formed by assembling a plurality of members. The base member 10X illustrated here includes two base members (a first base member and a second base member) assembled to each other. The two base members may be members having different shapes, or may be identical members having the same shape. In the grommet 1 illustrated here, identical members (base members 10 and 10) having the same shape are used for the two base members (FIGS. 1 to 9).

The base member 10X includes at least an annular flange 20 and a cylindrical body 30 coaxially, and the wiring member We is inserted thereinto (FIGS. 1 and 2). The base member 10X illustrated here includes a tubular body 40 coaxial with the flange 20 and the cylindrical body 30 in addition to the flange 20 and the cylindrical body 30, and the wiring member We is inserted thereinto (FIGS. 1 and 2). Here, on the same axis, the cylindrical body 30 protrudes from the flange 20 toward one side, and the tubular body 40 protrudes from the flange 20 toward the other side.

In the base member 10X illustrated here, as will be described later, the annular flange 20, the cylindrical body 30, and the tubular body 40 are coaxially formed by the base members 10 and 10 assembled to each other. Therefore, a holding mechanism (hereinafter referred to as a “base holding mechanism”) 50 for holding the two base members 10 and 10 in an assembled state therebetween is provided between the two base members (FIGS. 1 to 3 and FIGS. 6 to 8).

In addition, the grommet 1 includes an annular grommet body 60 coaxially assembled to the base member 10X (the base members 10 and 10 assembled to each other) (FIGS. 1 to 8). The grommet body 60 is disposed in the one space S1 at an attachment completion position of the grommet 1 with respect to the peripheral edge portion 503 in order to prevent liquid (water or the like) from entering from one space S1 to the other space S2 through the through hole 502 (FIGS. 2 and 5). In the following description, when the “attachment completion position” is simply written, this indicates the attachment completion position of the grommet 1 with respect to the peripheral edge portion 503.

The base member 10X (the base members 10 and 10) is formed using an insulating hard synthetic resin material (hereinafter referred to as a “hard resin”). Here, for example, the base member 10X (the base members 10 and 10) is formed using a hard resin such as plastic.

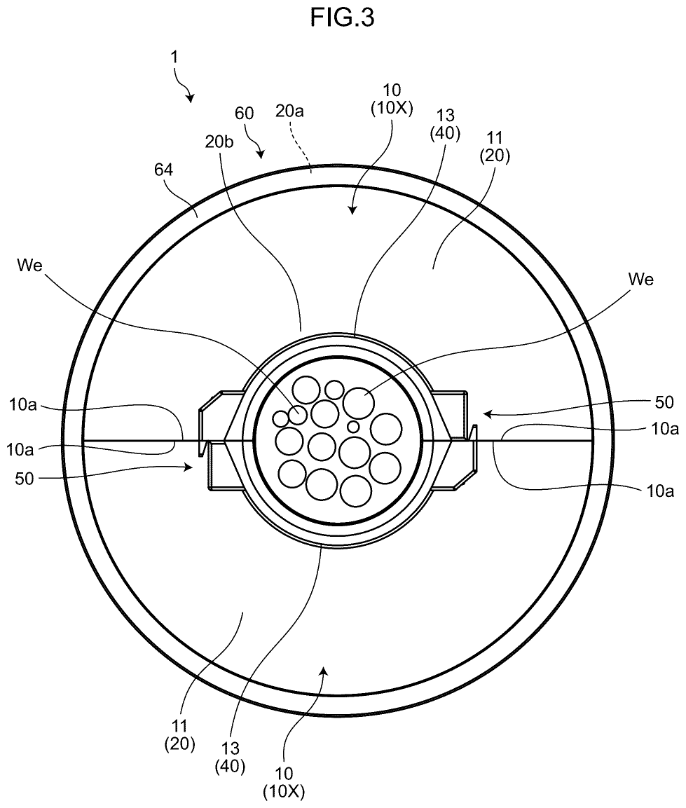

The two base members 10 and 10 are assembled by combining their joint surfaces 10a (FIGS. 3, 4, 6, and 7). In a state where the two base members 10 and 10 are assembled together, the wiring member We is sandwiched therebetween, and the wiring member We is inserted therebetween. Here, the annular flange 20, the cylindrical body 30 having a shape like a circular cylinder, and the tubular body 40 having a shape like a circular tube are formed by assembling the two base members 10 and 10. Here, the tubular body 40 that is a straight tube is taken as an example. However, the tubular body 40 may be bent after protruding from the flange 20.

The flange 20 is disposed in one space S1 at the attachment completion position, with an outer peripheral edge portion 20a thereof being coaxially disposed to face the peripheral edge portion 503 with a gap therebetween (FIG. 5). Then, the wiring member We is inserted inside an inner peripheral edge portion 20b of the flange 20 (FIG. 5). The flange 20 has an annular wall surface 20c on the peripheral edge portion 503 side (hereinafter referred to as a “first annular wall surface”) and an annular wall surface 20d on the back side thereof (hereinafter referred to as a “second annular wall surface”) (FIGS. 5 to 8). Specifically, the flange 20 is disposed such that the first annular wall surface 20c on the outer peripheral edge portion 20a side coaxially faces an annular flat surface 503a of the peripheral edge portion 503 on one space S1 side with a gap therebetween. The annular flat surface 503a is provided on the annular flat plate portion 504. The annular flat surface 503a illustrated here is an annular flat surface itself on the one space S1 side of the annular flat plate portion 504. The flange 20 is formed in an annular plate shape in which the first annular wall surface 20c and the second annular wall surface 20d are annular flat surfaces. For example, the flange 20 is formed in a shape similar to the annular flat surface 503a having an annular shape. The flange 20 illustrated here is disposed such that the first annular wall surface 20c on the annular outer peripheral edge portion 20a side faces the annular flat surface 503a on the inner peripheral edge portion 504a side of the annular flat plate portion 504, with the wiring member We being inserted inside the annular inner peripheral edge portion 20b.

Each of the two base members 10 and 10 has a split flange 11 that forms the flange 20 by combining the joint surfaces 10a of the two base members 10 and 10 to each other (FIGS. 1 to 8). The split flange 11 illustrated here is obtained by dividing the flange 20 in half along the central axis, and is formed in a semicircular arc shape.

The cylindrical body 30 protrudes coaxially from the flange 20 toward the other space S2, and is inserted into the through hole 502 at the attachment completion position (FIGS. 2 and 5). That is, a distal end of the cylindrical body 30 protruding from the flange 20 is disposed in the other space S2. The cylindrical body 30 is formed in a shape like a circular cylinder. For example, a cross section of the cylindrical body 30 orthogonal to the hole axis of the through hole 502 is formed in a shape similar to a cross section of the annular protruding portion 505 orthogonal to the hole axis. The cylindrical body 30 illustrated here protrudes from the inner peripheral edge portion 20b side, rather than the outer peripheral edge portion 20a side, of the first annular wall surface 20c of the flange 20, and the wiring member We is inserted thereinto (FIG. 5).

Each of the two base members 10 and 10 has a split cylinder 12 that forms the cylindrical body 30 by combining the joint surfaces 10a of the two base members 10 and 10 to each other (FIGS. 2 and 4 to 8). The split cylinder 12 illustrated here is obtained by splitting the cylindrical body 30 in half along the central axis, and is formed in a semicircular arc shape.

The tubular body 40 protrudes coaxially from the flange 20 in a direction opposite to the cylindrical body 30 (FIG. 5). The tubular body 40 is formed in a shape like a circular tube. For example, a cross section of the tubular body 40 orthogonal to the hole axis of the through hole 502 is formed in a shape similar to a cross section of the annular protruding portion 505 orthogonal to the hole axis. The tubular body 40 illustrated here protrudes from the inner peripheral edge portion 20b of the flange 20, and the wiring member We is inserted thereinto (FIG. 5).

Each of the two base members 10 and 10 has a split tube 13 that forms the tubular body 40 by combining the joint surfaces 10a of the two base members 10 and 10 to each other (FIGS. 1 to 3 and 5 to 8). The split tube 13 illustrated here is obtained by splitting the tubular body 40 in half along the central axis, and is formed in a semicircular arc shape.

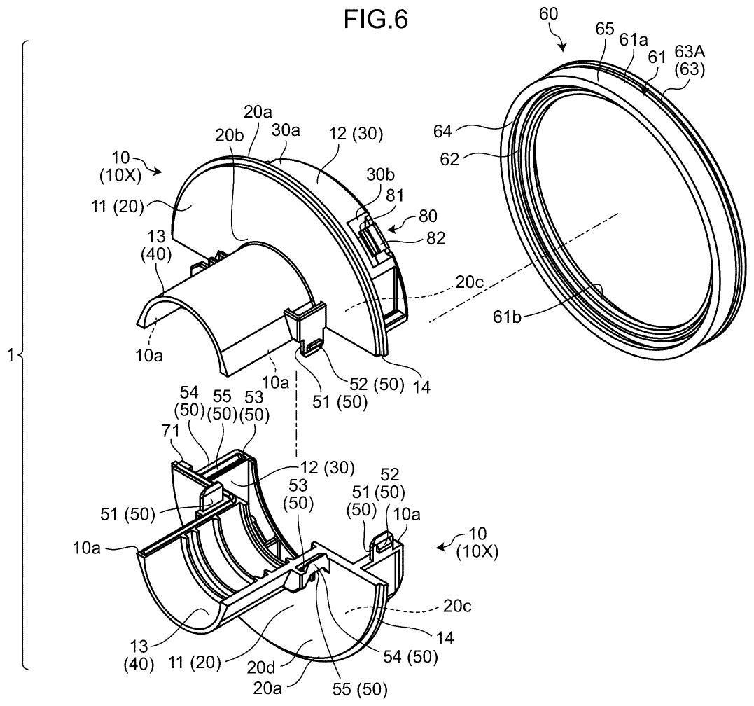

As described above, the main parts (the split flanges 11, the split cylinders 12, and the split tubes 13) of the two base members 10 and 10 have high hardness so as to be hardly elastically deformed. For this reason, the two base members 10 and 10 may form fine gaps between their joint surfaces 10a, for example, due to the surface roughness of the joint surfaces 10a. Therefore, the grommet 1 according to the present embodiment includes, on at least one of the joint surfaces 10a of the two base members 10 and 10, a waterproof member 71 that is made of a synthetic resin material softer than the hard resin of the base member 10 and is elastically deformable (hereinafter referred to as a “soft resin”) to eliminate gaps between the joint surfaces 10a (FIGS. 6, 7, and 9).

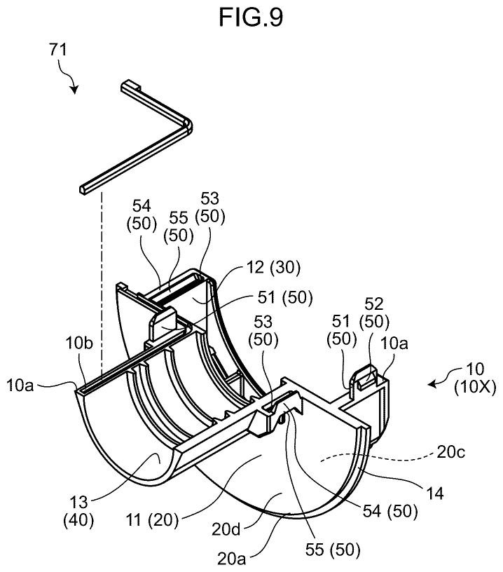

The waterproof member 71 is formed using, for example, a synthetic resin material such as an elastomer. The waterproof member 71 is provided, for example, on the joint surface 10a over the split flange 11, the split cylinder 12, and the split tube 13. In the base member 10 illustrated here, a groove portion 10b is formed in one of the two joint surfaces 10a from the split flange 11 to the split tube 13, and the waterproof member 71 is fitted into the groove portion 10b (FIG. 9). The waterproof member 71 protrudes from the groove portion 10b. For example, the waterproof member 71 is formed integrally with the base member 10 by two-color molding with the base member 10 or by insert molding with respect to the base member 10 housed in a mold. In addition, the waterproof member 71 may be formed as a component separate from the base member 10, and may be attached to the groove portion 10b of the base member 10 using an adhesive or the like. In the base member 10X, by assembling the two base members 10 and 10, the waterproof member 71 protruding from the groove portion 10b of the one joint surface 10a of the one base member 10 is brought into tight contact with the other joint surface 10a of the other base member 10.

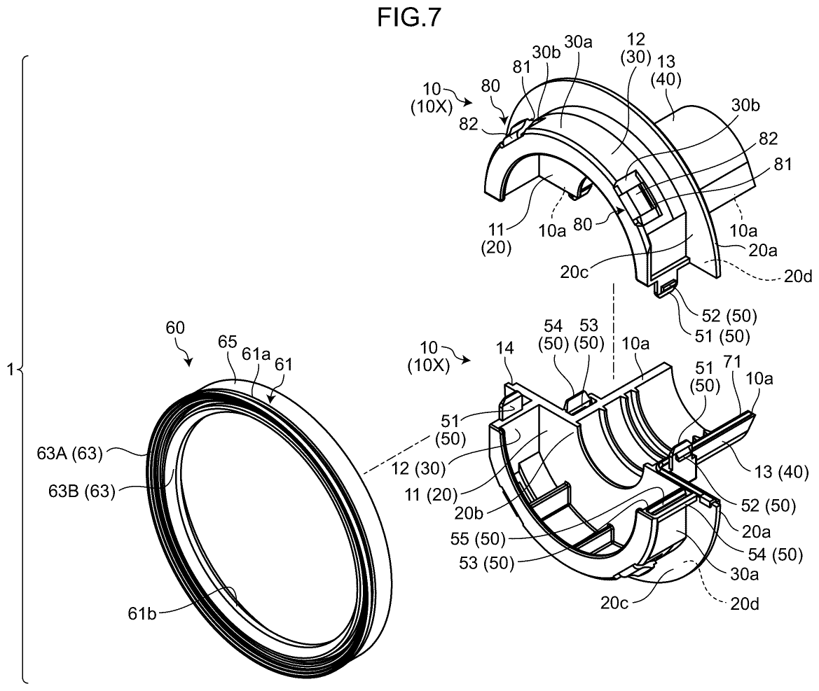

A base holding mechanism 50 is a holding mechanism for holding the two base members 10 and 10 in a state where their joint surfaces 10a are combined together. The base holding mechanisms 50 are provided at a plurality of positions between the two base members 10 and 10. For example, the base holding mechanism 50 illustrated here includes a piece portion 51 protruding from the joint surface 10a of one of the two base members 10 and 10, and a claw-shaped first locking portion 52 protruding from a wall surface of the piece portion 51 (FIGS. 6 and 7). Further, the base holding mechanism 50 illustrated here includes: an insertion port 53 provided in the joint surface 10a of the other one of the two base members 10 and 10 to allow the piece portion 51 and the first locking portion 52 formed on the one base member 10 to be inserted thereinto; a flexible portion 54 provided in the other one of the two base members 10 and 10, bent when pushed by the first locking portion 52 inserted from the insertion port 53, and unbent when the joint surfaces 10a are combined together and the first locking portion 52 is separated; and a second locking portion 55 provided in the other one of the two base members 10 and 10 and disposed to face the first locking portion 52 when the joint surfaces 10a are combined together to hold the two base members 10 and 10 in a state where their joint surfaces 10a are combined together (FIGS. 6 and 7).

Each of the two base members 10 and 10 illustrated here includes a set of a piece portion 51 and a first locking portion 52 at one end of the split cylinder 12 in the circumferential direction, and a set of an insertion port 53, a flexible portion 54, and a second locking portion 55 at the other circumferential end of the split cylinder 12. In a state where the joint surfaces 10a of the two base members 10 and 10 are combined together, the first locking portion 52 at one end of the one split cylinder 12 and the second locking portion 55 at the other end of the other split cylinder 12 are locked, and the second locking portion 55 at the other end of the one split cylinder 12 and the first locking portion 52 at one end of the other split cylinder 12 are locked. That is, in the two base members 10 and 10, the base holding mechanisms 50 that connect the split cylinders 12 to each other to hold the two base members 10 and 10 in the connected state are provided at two locations. Furthermore, each of the two base members 10 and 10 includes a set of a piece portion 51 and a first locking portion 52 at one end of the split tube 13 in the circumferential direction, and includes a set of an insertion port 53, a flexible portion 54, and a second locking portion 55 at the other circumferential end of the split tube 13. In a state where the joint surfaces 10a of the two base members 10 and 10 are combined together, the first locking portion 52 at one end of the one split tube 13 and the second locking portion 55 at the other end of the other split tube 13 are locked, and the second locking portion 55 at the other end of the one split tube 13 and the first locking portion 52 at one end of the other split tube 13 are locked. That is, in the two base members 10 and 10, the base holding mechanisms 50 that connect the split tubes 13 to each other to hold the two base members 10 and 10 in the connected state are provided at two locations.

The grommet body 60 is an annular water-blocking member made of a soft resin (that is, an elastically deformable synthetic resin material softer than the hard resin of the base member 10X (base member 10)). The grommet body 60 is formed using, for example, a synthetic resin material such as an elastically deformable elastomer softer than the hard resin of the base member 10X (base member 10).

The grommet body 60 includes an annular body 61 coaxially disposed to face the outer peripheral edge portion 20a of the flange 20 with a gap therebetween at the assembly completion position with respect to the base member 10X (the base members 10 and 10 assembled to each other), and coaxially disposed to face the peripheral edge portion 503 with a gap therebetween at the attachment completion position (FIGS. 1, 2, and 5 to 8). The grommet body 60 is formed in an annular shape. Therefore, the annular body 61 is formed in an annular plate shape. In the following description, when the “assembly completion position” is simply written, this indicates the assembly completion position of the grommet body 60 with respect to the base member 10X (the base members 10 and 10 assembled to each other).

The grommet body 60 is coaxially brought into tight contact with the outer peripheral edge portion 20a of the flange 20 at the assembly completion position. For example, in the grommet body 60, the annular body 61 is coaxially disposed to face the first annular wall surface 20c of the flange 20 on the outer peripheral edge portion 20a side with a gap therebetween at the assembly completion position (FIG. 5). Therefore, the grommet body 60 has an annular lip 62 (hereinafter referred to as a “first lip”) protruding coaxially from the annular body 61 to be elastically deformed and brought into tight contact with the outer peripheral edge portion 20a of the flange 20 over the entire circumference at the assembly completion position (FIGS. 5, 6, and 8). The first lip 62 is elastically deformed and brought into tight contact with the first annular wall surface 20c of the flange 20 on the outer peripheral edge portion 20a side over the entire circumference at the assembly completion position.

In addition, the grommet body 60 is coaxially brought into tight contact with the peripheral edge portion 503 at the attachment completion position. For example, in the grommet body 60, the annular body 61 is coaxially disposed to face the annular flat surface 503a of the peripheral edge portion 503 with a gap therebetween at the attachment completion position (FIG. 5). Therefore, the grommet body 60 has an annular lip 63 (hereinafter referred to as a “second lip”) protruding coaxially from the annular body 61 to be elastically deformed and brought into tight contact with the peripheral edge portion 503 over the entire circumference at the attachment completion position (FIGS. 1, 2, and 4 to 8). The second lip 63 is elastically deformed and brought into tight contact with the annular flat surface 503a of the peripheral edge portion 503 over the entire circumference at the attachment completion position.

The grommet body 60 includes, as the second lip 63, an outer peripheral lip 63A provided on an outer peripheral edge portion 61a side of the annular body 61 and coaxial with the annular body 61, and an inner peripheral lip 63B provided on an inner peripheral edge portion 61b side of the annular body 61 and coaxial with the annular body 61 (FIGS. 2, 4, 5, and 7).

The grommet body 60 includes a first annular portion 64 coaxially disposed to face the outer peripheral edge portion 61a of the annular body 61 on the outer peripheral edge portion 20a side of the flange 20 with a gap therebetween, and a second annular portion 65 coaxially protruding from the outer peripheral edge portion 61a of the annular body 61 toward the flange 20 and connecting the outer peripheral edge portion 61a of the annular body 61 to an outer peripheral edge portion of the first annular portion 64 (FIGS. 1, 5, 6, and 8). The first annular portion 64 and the second annular portion 65 serve as one end of a holding mechanism that holds the base member 10X (the base members 10 and 10 assembled to each other) and the grommet body 60 at their assembly completion positions, and function together with the first lip 62 and the outer peripheral edge portion 20a of the flange 20 (FIGS. 1, 3, 5, 6, and 8).

The holding mechanism keeps the base member 10X (the base members 10 and 10 assembled to each other) and the grommet body 60 at their assembly completion positions by sandwiching the outer peripheral edge portion 20a of the flange 20 between the first annular portion 64 and the first lip 62 (FIG. 5). Therefore, the first annular portion 64 is hooked to the outer peripheral edge portion 20a of the flange 20 from the second annular wall surface 20d side over the entire circumference at the assembly completion position. At the assembly completion position, the first lip 62 is elastically deformed and brought into tight contact with the first annular wall surface 20c of the flange 20 on the outer peripheral edge portion 20a side over the entire circumference. Therefore, the outer peripheral edge portion 20a of the flange 20 is sandwiched between the first annular portion 64 and the first lip 62 at the assembly completion position.

Specifically, the outer peripheral edge portion 20a of the flange 20 has a concentric annular groove portion 14 recessed from the outer peripheral surface on the second annular wall surface 20d side (FIGS. 5 to 8). The outer peripheral edge portion 20a illustrated here has a concentric annular groove portion 14 as if an annular corner portion on the outer peripheral surface side and on the second annular wall surface 20d side is cut away. The first annular portion 64 is inserted into the annular groove portion 14 at the assembly completion position, and is hooked to the outer peripheral edge portion 20a of the flange 20 in the annular groove portion 14 over the entire circumference from the second annular wall surface 20d side.

In the grommet 1, when the base member 10X (the base members 10 and 10 assembled to each other) and the grommet body 60 are assembled together, the first annular portion 64 is inserted into the annular groove portion 14 while being bent, and the first annular portion 64 and the second annular portion 65 are covered with the outer peripheral edge portion 20a of the flange 20. As a result, in the grommet 1, the outer peripheral edge portion 20a of the flange 20 is sandwiched between the first annular portion 64 and the first lip 62 at the assembly completion position, and the grommet body 60 is held by the outer peripheral edge portion 20a. Therefore, the grommet 1 can keep the base member 10X (the base members 10 and 10 assembled to each other) and the grommet body 60 at the assembly completion position.

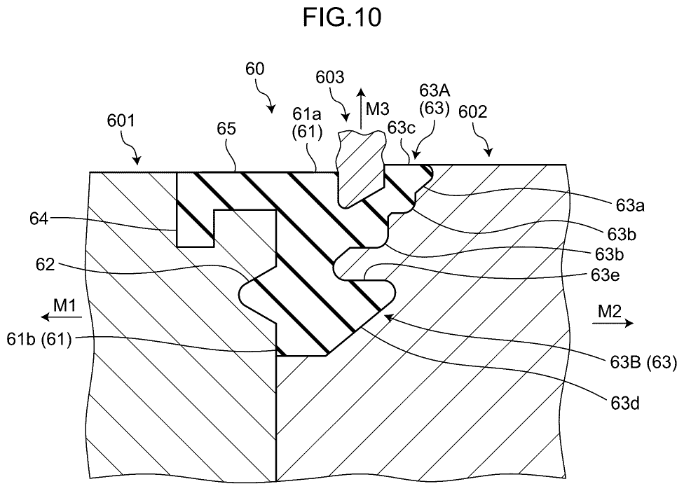

In the grommet body 60, the annular body 61, the first lip 62, the first annular portion 64, and the second annular portion 65 are formed by a first mold 601, and the second lip 63 (the outer peripheral lip 63A and the inner peripheral lip 63B) is formed by a second mold 602 (FIG. 10). After forming the grommet body 60, the first mold 601 is removed in a removal direction M1 toward one side in the axial direction of the annular body 61. After forming the grommet body 60, the second mold 602 is removed in a removal direction M2 toward the other side in the axial direction of the annular body 61.

The first lip 62 is formed in an annular shape in such a manner as to bulge from the annular body 61 in the removal direction M1 of the first mold 601 and have an arc-shaped outer wall surface orthogonal to the circumferential direction. The second annular portion 65 protrudes from the annular body 61 in the removal direction M1 of the first mold 601. Therefore, in the grommet body 60, the load applied to the annular body 61, the first lip 62, and the second annular portion 65 from the first mold 601 can be reduced when the first mold 601 is removed in the removal direction M1.

On the other hand, the first annular portion 64 protrudes from the second annular portion 65 toward the axis of the second annular portion 65 over the entire circumference, and is coaxially disposed to face the outer peripheral edge portion 61a of the annular body 61 with a gap therebetween, so that an annular space is formed between the annular body 61 and the second annular portion 65. The annular space serves as an undercut portion when the first mold 601 is removed in the removal direction M1. Therefore, the first annular portion 64 protrudes from the second annular portion 65 by a minimum protrusion amount within a range in which the first annular portion 64 can be kept hooked to the outer peripheral edge portion 20a of the flange 20, and the depth (the depth in the direction orthogonal to the axis) of the annular space (undercut portion) is made as shallow as possible.

In the grommet body 60, by coaxially disposing the annular first annular portion 64 to face the outer peripheral edge portion 61a of the annular body 61 with a gap therebetween, the inner diameter of the first annular portion 64 is larger than the inner diameter of the annular body 61. In the grommet body 60, the outer diameter of the annular body 61 is the same as the outer diameter of the flange 20, and by hooking the first annular portion 64 to the outer peripheral edge portion 20a of the flange 20 on the outer peripheral surface side, the position of the inner peripheral surface of the first annular portion 64 can be brought close to the outer peripheral edge portion 61a of the annular body 61 on the outer peripheral surface side in the radial direction. That is, in the grommet body 60, the inner diameter of the first annular portion 64 is significantly larger than the inner diameter of the annular body 61. Therefore, in the grommet body 60, the depth of the annular space (undercut portion) can be made as shallow as possible. Therefore, in the grommet body 60, the load applied to the annular body 61, the first lip 62, the first annular portion 64, and the second annular portion 65 from the first mold 601 can be reduced when the first mold 601 is removed in the removal direction M1.

The outer peripheral lip 63A protrudes to be separated from the axis of the annular body 61 (the hole axis of the through hole 502) as the distance from the annular body 61 increases in the removal direction M2 of the second mold 6 602. The outer peripheral lip 63A has two annular sub lip portions 63b on a radially inner wall surface 63a, the two annular sub lip portions 63b coaxially protruding from the wall surface 63a in the removal direction M2 of the second mold 602 (FIG. 10). The outer peripheral lip 63A is flexurally deformed from the root on the annular body 61 side at the attachment completion position, and the two sub lip portions 63b are brought into tight contact with the annular flat surface 503a of the peripheral edge portion 503. A radially outer wall surface 63c of the outer peripheral lip 63A is formed by at least two third molds 603 removed in a removal direction M3 toward the radially outward direction. As a result, the load applied to the grommet body 60 from the third molds 603 can be reduced when the third molds 603 are removed in the removal direction M3.

The inner peripheral lip 63B has an inner peripheral surface 63d inclined to be separated from the axis of the annular body 61 (the hole axis of the through hole 502) as the distance from the annular body 61 increases in the removal direction M2 of the second mold 602, and an outer peripheral surface 63e parallel to the removal direction M2 of the second mold 602 (FIG. 10).

The shape of the second lip 63 (the outer peripheral lip 63A and the inner peripheral lip 63B) makes it possible to reduce the load applied to the grommet body 60 from the second mold 602 when the second mold 602 is removed in the removal direction M2.

The grommet 1 configured as described above includes a holding mechanism 80 that holds the base member 10X (the base members 10 and 10 assembled to each other) and the grommet body 60 assembled to each other in the peripheral edge portion 503 of the through hole 502 in the insertion object 501 (FIGS. 2 and 4 to 8). The holding mechanism 80 illustrated here uses a resilient force caused by the elastic deformation of the second lip 63 (the outer peripheral lip 63A and the inner peripheral lip 63B) of the grommet body 60, and sandwiches the peripheral edge portion 503 between the second lip 63 (the outer peripheral lip 63A and the inner peripheral lip 63B) and a locking portion 81 provided in the base member 10X (base member 10), which will be described below, to hold the grommet 1 in the peripheral edge portion 503.

The base member 10X has a locking portion 81 that protrudes beyond an outer peripheral surface 30a of the cylindrical body 30 in the other space S2 at the attachment completion position, and comes into contact with the peripheral edge portion 503 from the other space S2 side in the other space S2 at the attachment completion position (FIGS. 2 and 5 to 8). The locking portion 81 locks a portion of the peripheral edge portion 503 in the circumferential direction. Therefore, the base member 10X has a plurality of locking portions 81 in the circumferential direction of the cylindrical body 30.

In addition, the base member 10X has a cantilevered locking piece portion 82 with the locking portion 81 provided at its free end in the other space S2 at the attachment completion position for each locking portion 81 (FIGS. 2 and 4 to 8). The locking piece portion 82 protrudes from the outer peripheral surface 30a of the cylindrical body 30 on a free end side, the free end being a tip protruding from a fixed end on the outer peripheral surface 30a side of the cylindrical body 30 toward the one space S1 in the other space S2 at the attachment completion position (initial shape). The locking piece portion 82 is formed to have flexibility so that it is flexurally deformable to change an amount of protrusion from the outer peripheral surface 30a on the free end side. The locking piece portion 82 moves back and forth through a cutout portion 30b obtained by cutting out a part of the cylindrical body 30 due to the flexurally deformation (FIGS. 2 and 4 to 8). A plurality of sets each being a combination of the locking portion 81, the locking piece portion 82, and the cutout portion 30b are provided at equal intervals in the circumferential direction in the cylindrical body 30. In the cylindrical body 30 illustrated here, four sets each being a combination of the locking portion 81, the locking piece portion 82, and the cutout portion 30b are provided at equal intervals in the circumferential direction. Here, two sets each being a combination of the locking portion 81, the locking piece portion 82, and the cutout portion 30b are provided in the split cylinder 12 of each base member 10.

When the cylindrical body 30 is inserted into the through hole 502 from the one space S1, the locking piece portion 82 receives a force from the annular protruding portion 505 of the peripheral edge portion 503, and is flexurally deformed from its initial shape toward the cutout portion 30b. When the locking piece portion 82 passes through the position of the annular protruding portion 505, and advances to a distal end 505a (hereinafter referred to as a “locking end portion”) of the annular protruding portion 505 (FIGS. 2 and 5), and the locking piece portion 82 starts to return to the initial shape as the force received from the annular protruding portion 505 is released. Therefore, the locking piece portion 82 is disposed at the locking end portion 505a of the annular protruding portion 505 together with the locking portion 81. On the other hand, when a series of movements of the locking portion 81 and the locking piece portion 82 occurs, the second lip 63 (the outer peripheral lip 63A and the inner peripheral lip 63B) of the grommet body 60 abuts against the peripheral edge portion 503 on the annular flat surface 503a side and is flexurally deformed. Therefore, when the force (so-called insertion force) for inserting the grommet 1 into the through hole 502 is released, the grommet 1 returns toward the one space S1 due to the resilient force caused by the elastic deformation of the second lip 63 (the outer peripheral lip 63A and the inner peripheral lip 63B). Accordingly, the locking portion 81 comes into contact with the locking end portion 505a of the annular protruding portion 505, and is locked by the locking end portion 505a (FIG. 5). That is, the annular protruding portion 505 locks the locking portion 81 at the distal end (the locking end portion 505a) protruding from the annular flat plate portion 504. The annular locking end portion 505a locks the locking portion 81 at each location in the circumferential direction. Therefore, the peripheral edge portion 503 is sandwiched by the second lip 63 (the outer peripheral lip 63A and the inner peripheral lip 63B) of the grommet body 60 and the locking portions 81 of the base member 10X (the base members 10 and 10).

In the grommet 1 according to the present embodiment described above, in a state where the first lip 62 is brought into tight contact with the first annular wall surface 20c of the flange 20 on the outer peripheral edge portion 20a side, the first annular portion 64 is hooked to the outer peripheral edge portion 20a of the flange 20 from the second annular wall surface 20d side, and the outer peripheral edge portion 20a of the flange 20 is sandwiched between the first annular portion 64 and the first lip 62. Therefore, in the grommet 1, since the grommet body 60 is held by the outer peripheral edge portion 20a of the flange 20 at the assembly completion position, the base member 10X (the base members 10 and 10 assembled to each other) and the grommet body 60 can be kept at their assembly completion positions. In the grommet body 60 according to the present embodiment, the inner diameter of the first annular portion 64 can be made significantly larger than the inner diameter of the annular body 61, and the depth of the annular space (undercut portion) between the annular body 61, the first annular portion 64, and the second annular portion 65 can be made as shallow as possible. Therefore, in the grommet body 60, the first mold 601 can be removed in the removal direction M1 without applying an excessive load to the annular body 61, the first lip 62, the first annular portion 64, and the second annular portion 65, and the second mold 602 can be removed in the removal direction M2 without applying an excessive load to the second lip 63 (the outer peripheral lip 63A and the inner peripheral lip 63B) (FIG. 10). Therefore, the grommet 1 according to the present embodiment can include the grommet body 60 in which deterioration in quality is suppressed.

In the grommet according to the present embodiment, in a state where the first lip is brought into tight contact with the first annular wall surface of the flange on the outer peripheral edge portion side, the first annular portion is hooked to the outer peripheral edge portion of the flange from the second annular wall surface side, and the outer peripheral edge portion of the flange is sandwiched between the first annular portion and the first lip. Therefore, in the grommet, since the grommet body is held by the outer peripheral edge portion of the flange at the assembly completion position, the base member and the grommet body can be kept at their assembly completion positions.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A grommet comprising:
a cylindrical base member into which a conductive wiring member is inserted to pass from one space to another space through a through hole of an insertion object, the base member being made of a hard synthetic resin material; and
an annular grommet body coaxially assembled to the base member, and disposed in the one space at an attachment completion position with respect to a peripheral edge portion of the through hole of the insertion object, wherein
the base member includes:
an annular flange disposed in the one space at the attachment completion position and having an outer peripheral edge portion coaxially disposed to face the annular peripheral edge portion with a gap therebetween; and
a cylindrical body protruding coaxially from the flange toward the another space and inserted into the through hole at the attachment completion position,
the grommet body is an annular water-blocking member made of an elastically deformable synthetic resin material softer than the base member to be coaxially brought into tight contact with the outer peripheral edge portion of the flange at an assembly completion position with respect to the base member, and coaxially brought into tight contact with the peripheral edge portion at the attachment completion position,
the grommet body includes:
an annular body coaxially disposed to face a first annular wall surface of the flange on an outer peripheral edge portion side at the assembly completion position with a gap therebetween, and coaxially disposed to face the peripheral edge portion at the attachment completion position with a gap therebetween;
an annular lip protruding coaxially from the annular body, and elastically deformed at the assembly completion position to be brought into tight contact with the first annular wall surface of the flange on the outer peripheral edge portion side over an entire circumference;
a first annular portion coaxially disposed to face an outer peripheral edge portion of the annular body on the outer peripheral edge portion side of the flange with a gap therebetween; and
a second annular portion protruding coaxially from the outer peripheral edge portion of the annular body toward the flange, and connecting the outer peripheral edge portion of the annular body to an outer peripheral edge portion of the first annular portion, and
the first annular portion is hooked to the outer peripheral edge portion of the flange from a second annular wall surface side on a back side of the first annular wall surface over an entire circumference at the assembly completion position.

2. The grommet according to claim 1, wherein
the outer peripheral edge portion of the flange has a concentric annular groove portion recessed from an outer peripheral surface on the second annular wall surface side, and
the first annular portion is inserted into the annular groove portion at the assembly completion position, and is hooked to the outer peripheral edge portion of the flange in the annular groove portion over the entire circumference from the second annular wall surface side.

3. The grommet according to claim 1, wherein
the outer peripheral edge portion of the flange has a concentric annular groove portion like cutting away an annular corner portion on the outer peripheral surface side and on the second annular wall surface side, and
the first annular portion is inserted into the annular groove portion at the assembly completion position, and is hooked to the outer peripheral edge portion of the flange in the annular groove portion over the entire circumference from the second annular wall surface side.
